(19) United States
(12) Patent Application Publication
(10) Pub. No.: US 2012/0029267 A1
(43) Pub. Date: Feb. 2, 2012

(54) Electromagnetic Bone Conduction Hearing Device

(75) Inventor: Geoffrey R. Ball, Axams (AT)

(73) Assignee: VIBRANT MED-EL HEARING TECHNOLOGY GMBH, Innsbruck (AT)

(21) Appl. No.: 13/163,965

(22) Filed: Jun. 20, 2011

Related U.S. Application Data
(60) Provisional application No. 61/356,717, filed on Jun. 21, 2010.

(51) Int. Cl. H04R 25/00

(52) U.S. Cl. 600/25

(57) ABSTRACT

An implantable hearing prosthesis for a recipient patient is described. An implantable attachment magnet is fixable beneath the skin of the patient to underlying skull bone and is adapted to magnetically connect with an external attachment magnet over the skin. An implantable signal transducer also is fixable beneath the skin of the patient to underlying skull bone and is adapted to transform a magnetic audio signal from an external signal drive coil into a corresponding mechanical stimulation signal for delivery by bone conduction of the skull bone as an audio signal to the cochlea. A connector member flexibly connects and positions the attachment magnet a fixed distance from the signal transducer.

This application claims priority from U.S. Provisional Patent 61/356,717, filed Jun. 21, 2010, which is incorporated herein by reference.

### FIELD OF THE INVENTION

The present invention relates to medical implants, and more specifically to a novel transcutaneous auditory prosthetic implant system.

### BACKGROUND ART

A normal ear transmits sounds as shown in FIG. 1 through the outer ear 101 to the tympanic membrane (eardrum) 102, which moves the ossicles of the middle ear 103 (malleus, incus, and stapes) that vibrate the oval window 106 and round window 107 membranes of the cochlea 104. The cochlea 104 is a long narrow duct wound spirally about its axis for approximately two and a half turns. It includes an upper channel known as the scala vestibuli and a lower channel known as the scala tympani, which are connected by the cochlear duct. The cochlea 104 forms an upright spiraling cone with a center called the modiolar where the spiral ganglion cells of the cochlear nerve 105 reside. In response to received sounds transmitted by the middle ear 103, the fluid-filled cochlea 104 functions as a transducer to generate electric pulses which are transmitted to the cochlear nerve 105, and ultimately to the brain.

Hearing is impaired when there are problems in the ability to transduce external sounds into meaningful action potentials along the neural substrate of the cochlea 104. To improve impaired hearing, auditory prostheses have been developed. For example, when the impairment is related to operation of the middle ear 103, a conventional hearing aid or middle ear implant may be used to provide acoustic-mechanical stimulation to the auditory system in the form of amplified sound. Or when the impairment is associated with the cochlea 104, a cochlear implant with an implanted stimulation electrode can electrically stimulate auditory nerve tissue with small currents delivered by multiple electrode contacts distributed along the electrode.

Middle ear implants employ electromagnetic transducers to convert sounds into mechanical vibration of the middle ear 103. A coil winding is held stationary by attachment to a non-vibrating structure within the middle ear 103 and microphone signal current is delivered to the coil winding to generate an electromagnetic field. A magnet is attached to an ossicle within the middle ear 103 so that the magnetic field of the magnet interacts with the magnetic field of the coil. The magnet vibrates in response to the interaction of the magnetic fields, causing vibration of the bones of the middle ear 103. See U.S. Pat. No. 6,190,305, which is incorporated herein by reference.

U.S. Patent Publication 20070191673 (incorporated herein by reference) describes another type of implantable hearing prosthesis system which uses bone conduction to deliver an audio signal to the cochlea for sound perception in persons with conductive or mixed conductive/sensorineural hearing loss. An implanted floating mass transducer (FMT) is affixed to the temporal bone. In response to an externally generated electrical audio signal, the FMT couples a mechanical stimulation signal to the temporal bone for delivery by bone conduction to the cochlea for perception as a sound signal. A certain amount of electronic circuitry must also be implanted with the FMT to provide power to the implanted device and at least some signal processing which is needed for converting the external electrical signal into the mechanical stimulation signal and mechanically driving the FMT.

### SUMMARY OF THE INVENTION

Embodiments of the present invention are directed to an implantable hearing prosthesis for a recipient patient. An implantable attachment magnet is fixable beneath the skin of the patient to underlying skull bone and is adapted to magnetically connect with an external attachment magnet over the skin. An implantable signal transducer also is fixable beneath the skin of the patient to underlying skull bone and is adapted to transform a magnetic audio signal from an external signal drive coil into a corresponding mechanical stimulation signal for delivery by bone conduction of the skull bone as an audio signal to the cochlea. A connector member flexibly connects and positions the attachment magnet a fixed distance from the signal transducer.

The attachment magnet and/or the signal transducer may include an outer ring magnet having a first magnetization direction and inner core magnet having an opposite second magnetization direction. The signal transducer may be adapted for fixed attachment to the skull bone by a pair of radially opposed bone screws, and/or into a recessed transducer well in the skull bone. The signal transducer may be hermetically enclosed, or enclosed by a biocompatible membrane.

Embodiments of the present invention also include an external component for an implantable hearing prosthesis of a recipient patient. An external attachment magnet is fixable on the skin and is adapted to magnetically connect with an implanted attachment magnet beneath the skin. An external signal drive coil provides a magnetic audio signal to a cooperating implant signal transducer beneath the skin. A connector member flexibly connects and positions the external attachment magnet a fixed distance from the signal drive coil.

Such embodiments may also include a processor housing containing the external attachment magnet, and a signal processor within the processor housing for generating an electrical audio signal output for development by the signal drive coil as the magnetic audio signal. There may be at least one sensing microphone for developing an audio input signal to the signal processor. And an external ring magnet may surround the signal drive coil and cooperate with a corresponding ring magnet in the implant signal transducer.

### BRIEF DESCRIPTION OF THE DRAWINGS

FIG. 1 shows anatomical structures of a typical human ear.

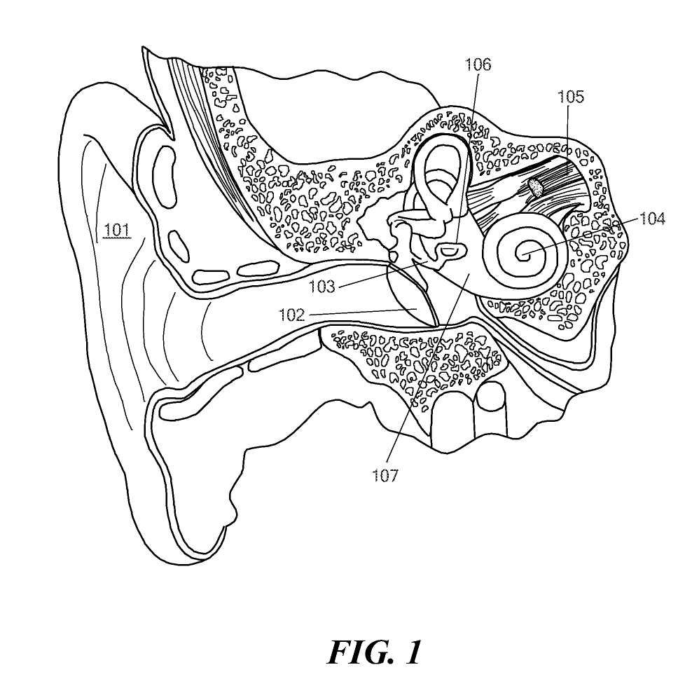

FIG. 2 shows a cross-sectional view of an implantable hearing prosthesis arrangement according to an embodiment of the present invention.

FIG. 3 A-B shows top plan views of the outside and internal structures of an external component for an embodiment of the invention.

FIG. 4 shows a top plan view of the implant portion of an embodiment of the invention.

### DETAILED DESCRIPTION OF SPECIFIC EMBODIMENTS

Various embodiments of the present invention are directed to an implantable hearing prosthesis for a recipient patient. An implant component and an external signal drive component each have two main lobes characterized by a distinctive magnet arrangement and a flexible connector member that maintains a constant distance between the two main lobes. One of the external main lobes contains a sensing microphone, an audio signal processor, and an attachment magnet which magnetically connects with a corresponding implant attachment magnet that forms one of the implant main lobes. The other external main lobe contains a ring drive magnet surrounding an electromagnetic signal drive coil that generates a magnetic drive signal from the signal processor which is representative of sound detected by the sensing microphone. The other implant main lobe is a ring magnet arrangement that is fixed to the skull bone to magnetically couple the magnetic drive signal to the skull bone which delivers the signal to the cochlea by bone conduction where it is sensed as sound by the patient.

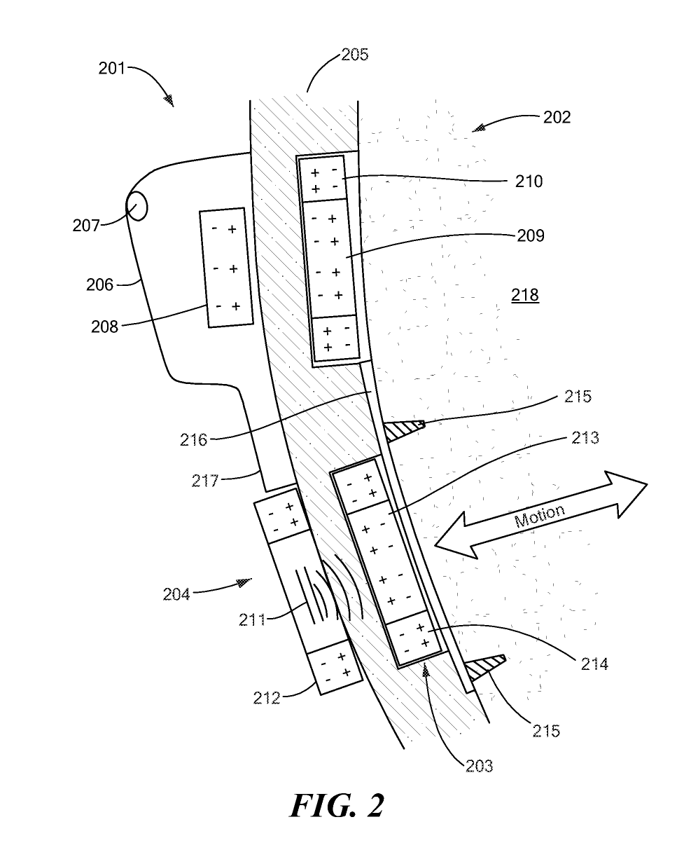

FIG. 2 shows a cross-sectional view of one exemplary embodiment of the present invention including an implantable attachment magnet 202 which is fixable beneath the skin 205 of the patient to underlying skull bone 218. The implantable attachment magnet 202 magnetically connects with a corresponding external attachment magnet 208 over the skin 205. An implantable signal transducer 203 magnetically cooperates with corresponding external signal drive coil 204 that provides an externally generated magnetic audio signal to couple a corresponding mechanical stimulation signal to the skull bone 218 for delivery by bone conduction as an audio signal to the cochlea. An implant connector member 216 flexibly connects and positions the attachment magnet 202 a fixed distance from the signal transducer 203. A corresponding external component 201 includes an external attachment magnet 208 that is fixable on the skin 205 to magnetically connect with the implant attachment magnet 202 beneath the skin 205. An external signal drive coil 204 provides the magnetic audio signal to the implant signal transducer 203 beneath the skin 205. An external connector member 217 flexibly connects and positions the external attachment magnet 208 a fixed distance from the signal drive coil 204.

In the embodiment shown in FIG. 2, the implant attachment magnet 202 is specifically implemented as an outer ring magnet 210 having a first magnetization direction and inner core magnet 209 having an opposite second magnetization direction. Likewise, the signal transducer 203 also includes an outer ring magnet 214 having a first magnetization direction and inner core magnet 213 having an opposite second magnetization direction. Such ring magnet arrangements minimize problems that can arise from strong external magnetic fields such as with magnetic resonance imaging. This subject is explored more fully in U.S. Provisional Patent Application 61/227,632, filed Jul. 22, 2009; which is incorporated herein by reference. In the embodiment shown in FIG. 2, the external attachment magnet 208 is a typical disk-shaped magnet sized adapted to magnetically connect with the inner core magnet 209 of the implant attachment magnet 202. In other embodiments, the external attachment magnet 208 may be like the implant attachment magnet 202 in having an inner core magnet that is surrounded by an outer ring magnet, both of which are sized and adapted to optimize the magnetic connection with the implant attachment magnet 202. Similarly, the external signal drive coil 204 shown in the embodiment in FIG. 2 includes an outer ring magnet 212 sized and magnetically adapted to optimize the cooperation with the outer ring magnet 214 of the implanted signal transducer 203. The inner core 211 of the signal drive coil 204 includes an electromagnetic coil (with or without a core) that produces the magnetic audio signal which is coupled across the skin to the implanted signal transducer 203.

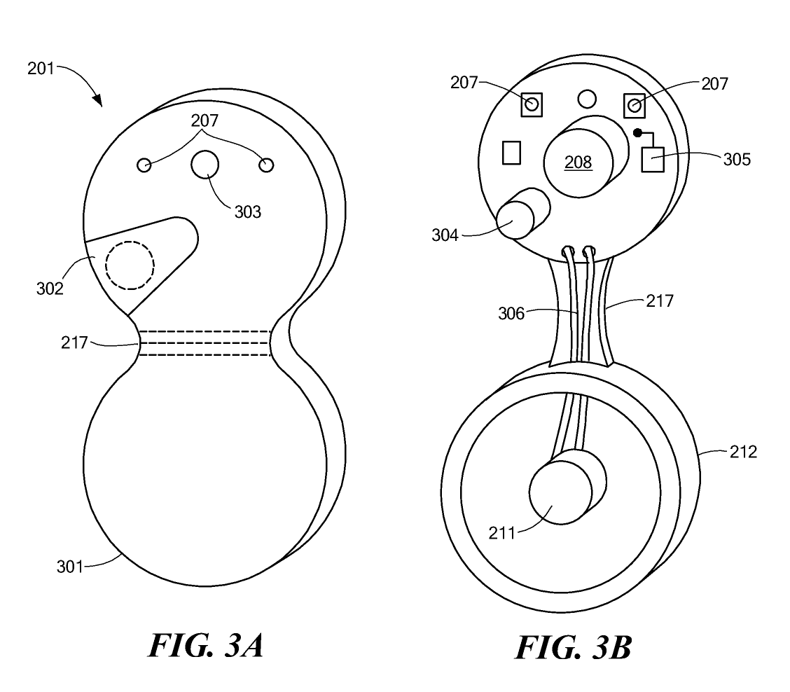

FIG. 3 A-B shows top plan views providing further detail regarding the outside and internal structures of the external component 201. The external attachment magnet 208 is contained within a processor housing 301 made of an impact resistant material such as plastic. A battery compartment 302 contains a battery power supply 304 that provides electrical power to the external component 201. The processor housing 301 also contains openings for one or more sensing microphones 207 that sense the nearby acoustic environment and generate a representative microphone signal output. A signal processor 305 within the processor housing 301 receives the microphone signal and generates a corresponding electrical stimulation signal output. Signal leads 303 in the flexible member 217 couple the electrical stimulation signal from the signal processor 305 to the signal drive coil 204 for output to the implant.

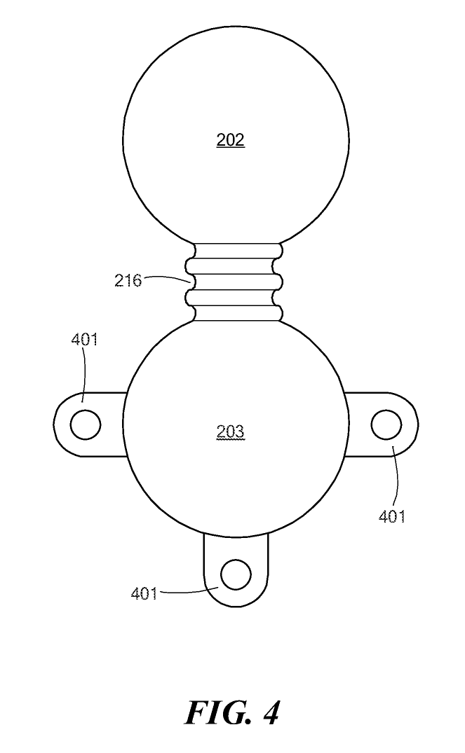

FIG. 4 shows a top plan view providing further detail regarding the implant portion used in FIG. 2. The implant signal transducer 203 may be adapted for fixed attachment to the skull bone 218 by one or more bone screws 215 through corresponding flange openings 401 distributed around the outer circumference of the implant signal transducer 203. Alternatively or in addition, some embodiments may be adapted for fixation of the signal transducer 203 in a prepared recessed transducer well in the skull bone 218. The lobe of the signal transducer 203 and/or the lobe of the implant attachment magnet 202 may be hermetically enclosed such as with a biocompatible membrane.

One advantage embodiments of the present invention possess which is lacking in earlier arrangements such as FMT-based systems is that there is no requirement that the implanted components include electronic circuits and associated power circuitry. The prior art has to convert a received electrical signal and therefore must have some necessary functional overhead including electrical power and signal conversion circuitry. But with embodiments of the present invention there is simply no requirement for any subcutaneous electronic circuitry.

Although various exemplary embodiments of the invention have been disclosed, it should be apparent to those skilled in the art that various changes and modifications can be made which will achieve some of the advantages of the invention without departing from the true scope of the invention.

What is claimed is:

1. An implantable hearing prosthesis for a recipient patient, the prosthesis comprising:
an implantable attachment magnet fixable beneath the skin of the patient to underlying skull bone and adapted to magnetically connect with an external attachment magnet over the skin;
an implantable signal transducer fixable beneath the skin of the patient to underlying skull bone and adapted to transform a magnetic audio signal from an external signal drive coil into a corresponding mechanical stimulation signal for delivery by bone conduction of the skull bone as an audio signal to the cochlea; and
a connector member flexibly connecting and positioning the attachment magnet a fixed distance from the signal transducer.

2. An implantable hearing prosthesis according to claim 1, wherein the attachment magnet includes an outer ring magnet having a first magnetization direction and inner core magnet having an opposite second magnetization direction.

3. An implantable hearing prosthesis according to claim 1, wherein the signal transducer includes an outer ring magnet having a first magnetization direction and inner core magnet having an opposite second magnetization direction.

4. An implantable hearing prosthesis according to claim 1, wherein the signal transducer is adapted for fixed attachment to the skull bone by a pair of radially opposed bone screws.

5. An implantable hearing prosthesis according to claim 1, wherein the signal transducer is adapted for fixed attachment into a recessed transducer well in the skull bone.

6. An implantable hearing prosthesis according to claim 1, wherein the signal transducer is hermetically enclosed.

7. An implantable hearing prosthesis according to claim 1, wherein the signal transducer is enclosed by a biocompatible membrane.

8. An external component for an implantable hearing prosthesis of a recipient patient, the component comprising:
an external attachment magnet fixable on the skin and adapted to magnetically connect with an implanted attachment magnet beneath the skin;
an external signal drive coil providing a magnetic audio signal to a cooperating implant signal transducer beneath the skin; and
a connector member flexibly connecting and positioning the external attachment magnet a fixed distance from the signal drive coil.

9. An external component according to claim 8, further comprising:
a processor housing containing the external attachment magnet; and
a signal processor within the processor housing for generating an electrical audio signal output to the signal drive coil.

10. An external component according to claim 9, further comprising:
at least one sensing microphone for developing an audio input signal to the signal processor.

11. An external component according to claim 8, further comprising:
an external ring magnet around the signal drive coil for cooperating with a corresponding ring magnet in the implant signal transducer.
